(19) United States
(12) Patent Application Publication
(10) Pub. No.: US 2026/0369845 A1
(43) Pub. Date: Nov. 19, 2026

(54) CYLINDRICAL BATTERY

(71) Applicant: Panasonic Energy Co., Ltd., Osaka (JP)

(72) Inventors: Kosuke FUKUI, Osaka (JP); Hiromichi WAKABAYASHI, Tokushima (JP); Takao IMAOKU, Nara (JP); Katsuya ITO, Tokushima (JP)

(21) Appl. No.: 19/155,139

(22) PCT Filed: Feb. 6, 2024
(86) PCT No.: PCT/JP2024/003825

§ 371 Date: Aug. 8, 2025

(30) Foreign Application Priority Data
Feb. 27, 2023 (JP) 2023-028519

(51) Int. Cl. H01M 50/595; H01M 10/0587; H01M 50/107

(52) U.S. Cl. CPC H01M 50/595; H01M 10/0587; H01M 50/107

(57) ABSTRACT

A cylindrical battery comprising a winding-type electrode body in which a positive electrode and a negative electrode, which includes a negative electrode core and a negative electrode mixture layer, are spirally wound via a separator, wherein the negative electrode has a tape which is pasted to a winding inner surface so as to extend in the winding direction across a first facing position facing the winding inner side of a winding start-side end of the positive electrode.

### TECHNICAL FIELD

The present disclosure relates to a cylindrical battery.

### BACKGROUND ART

A cylindrical battery comprises a wound electrode assembly in which a positive electrode and a negative electrode are spirally wound with a separator interposed therebetween. In the cylindrical battery, when charge and discharge cycles are repeated, the positive electrode and the negative electrode expand and contract, which may cause electrode plate deformation such that at least one of the positive electrode and the negative electrode is locally deformed.

For example, PATENT LITERATURE 1 discloses a cylindrical battery that comprises a wound electrode assembly having an insulating tape stuck to the negative electrode so as to straddle a surface of the negative electrode lead in a winding direction in order to suppress deformation of a joint portion of a negative electrode lead.

### CITATION LIST

### Patent Literature

PATENT LITERATURE 1: International Publication No. WO 2018/180748

### SUMMARY

Incidentally, in the cylindrical battery, a step is formed in a winding start side end portion of the positive electrode along a winding direction, which may cause deformation of a negative electrode portion facing an inner side of winding of the winding start side end portion of the positive electrode accompanied with charge and discharge cycles. In a case where deformation of the negative electrode portion occurs, a distance between the positive and negative electrodes varies, which may result in inhomogeneous charging and discharging reaction and degradation of cycle characteristics.

The insulating tape of PATENT LITERATURE 1 may not be able to sufficiently suppress the deformation of the negative electrode portion facing the inner side of the winding of the winding start side end of the positive electrode where the above-described step is formed. In PATENT LITERATURE 1, when the insulating tape is stuck to the negative electrode, the capacity of the cylindrical battery may decrease.

It is an advantage of the present disclosure to provide a cylindrical battery that can suppress deformation of a negative electrode portion facing a winding start side end portion of a positive electrode accompanied with charge and discharge cycles.

A cylindrical battery according to the present disclosure comprises an electrode assembly in which a positive electrode, and a negative electrode including a core and a mixture layer are spirally wound with a separator interposed between the positive electrode and the negative electrode, in which the negative electrode has a tape stuck to a winding inner surface so as to straddle, in a winding direction, a first facing position facing an inner side of winding of a winding start side end of the positive electrode.

According to the cylindrical battery of the present disclosure, there can be suppressed deformation of a negative electrode portion facing a winding start side end portion of a positive electrode accompanied with charge and discharge cycles.

### BRIEF DESCRIPTION OF DRAWING

FIG. 1 is an axial sectional view of a cylindrical battery which is one example of an embodiment.

FIG. 2 is a schematic diagram illustrating a radial cross section of a winding start side of an electrode assembly.

FIG. 3 is a schematic diagram illustrating, in a developed form, the winding start side of the electrode assembly.

FIG. 4 is a schematic diagram illustrating a radial cross section of FIG. 3.

### DESCRIPTION OF EMBODIMENTS

Hereinafter, one example of an embodiment of the present disclosure will be described in detail. In the following description, specific shapes, materials, directions, values, and the like, which are examples for facilitating understanding of the present disclosure, may be appropriately changed in accordance with use, purpose, specifications, or the like.

### [Cylindrical Battery]

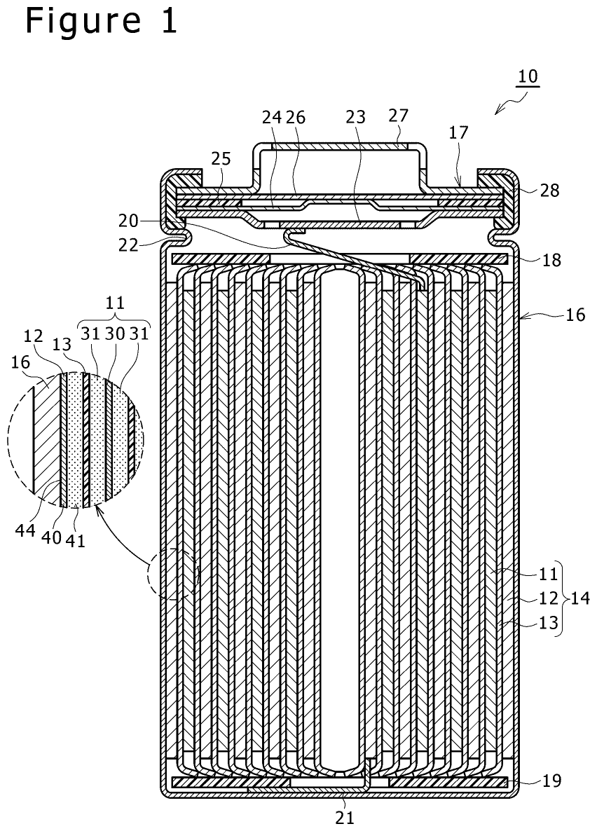

Referring to FIG. 1, a cylindrical battery 10 which is one example of an embodiment will be described.

The cylindrical battery 10 comprises an electrode assembly 14 that includes a positive electrode 11, a negative electrode 12, and a separator 13 and in which the positive electrode 11 and the negative electrode 12 are wound with the separator 13 interposed therebetween. In addition, the cylindrical battery 10 comprises a bottomed cylindrical exterior housing can 16 that houses the electrode assembly 14, and a sealing assembly 17 with which an opening portion of the exterior housing can 16 is capped. An electrolyte is housed together with the electrode assembly 14 in the exterior housing can 16. The exterior housing can 16 has a grooved portion 22 formed in a side wall, and the sealing assembly 17 is supported by the grooved portion 22 to cap the opening portion of the exterior housing can 16. Hereinafter, for convenience of description, the sealing assembly 17 side of the cylindrical battery 10 will be described as “the upper side”, and the bottom side of the exterior housing can 16 will be described as “the lower side”.

Although details will be described later, the negative electrode 12 includes a negative electrode core 40 and a negative electrode mixture layer 41, and has a tape 50 stuck to a winding inner surface so as to straddle, in a winding direction, a first facing position 12A facing a winding start side end 11A of the positive electrode 11. Using the tape 50 can suppress deformation of a portion of the negative electrode 12 facing an inner side of the winding of a winding start side end portion of the positive electrode 11 accompanied with charge and discharge cycles.

The electrolyte may be an aqueous electrolyte, but a non-aqueous electrolyte shall be used in the present embodiment. The non-aqueous electrolyte has a lithium ion conductivity. The non-aqueous electrolyte may be a liquid electrolyte (electrolytic solution) or a solid electrolyte. The cylindrical battery 10 is, for example, a non-aqueous secondary battery, and is preferably a lithium ion battery among the batteries.

The liquid electrolyte (electrolytic solution) includes a non-aqueous solvent, and an electrolyte salt dissolved in the non-aqueous solvent. For the non-aqueous solvent, esters, ethers, nitriles, amides, and mixed solvents containing two or more selected from the foregoing are used, for example. Examples of non-aqueous solvent include ethylene carbonate (EC), ethyl methyl carbonate (EMC), dimethyl carbonate (DMC), diethyl carbonate (DEC), and mixed solvents thereof. The non-aqueous solvent may contain a halogen-substituted product (for example, fluoroethylene carbonate) obtained by substituting at least some of hydrogen atoms in these solvents with a halogen atom such as fluorine. As the electrolyte salt, a lithium salt such as LiPF₆ is used.

As the solid electrolyte, for example, a solid-state or gel-like polymer electrolyte, an inorganic solid electrolyte, or the like can be used. As the inorganic solid electrolyte, a known material (for example, an oxide solid electrolyte, a sulfide solid electrolyte, a halogen solid electrolyte, or the like) of an all-solid lithium ion secondary battery or the like can be used. A polymer electrolyte includes, for example, a lithium salt and matrix polymer, or non-aqueous solvent, a lithium salt and matrix polymer. As the matrix polymer, for example, a polymer material that gelatinizes by absorbing the non-aqueous solvent is used. Examples of the polymer material include a fluorine resin, an acrylic resin, and a polyether resin.

As described above, the electrode assembly 14 has a wound structure in which the positive electrode 11 and the negative electrode 12 are spirally wound with the separator 13 interposed therebetween. Any of the positive electrode 11, the negative electrode 12, and the separator 13 is a band-shaped elongated member, and spirally wound to be alternately stacked in the radial direction of the electrode assembly 14. The negative electrode 12 is formed to be one size larger than the positive electrode 11 in order to prevent precipitation of lithium. That is, the negative electrode 12 is formed to be longer in the longitudinal direction and the width direction than the positive electrode 11. The two separators 13 are each formed to be at least one size larger than the positive electrode 11, and are disposed so as to interpose the positive electrode 11 therebetween, for example.

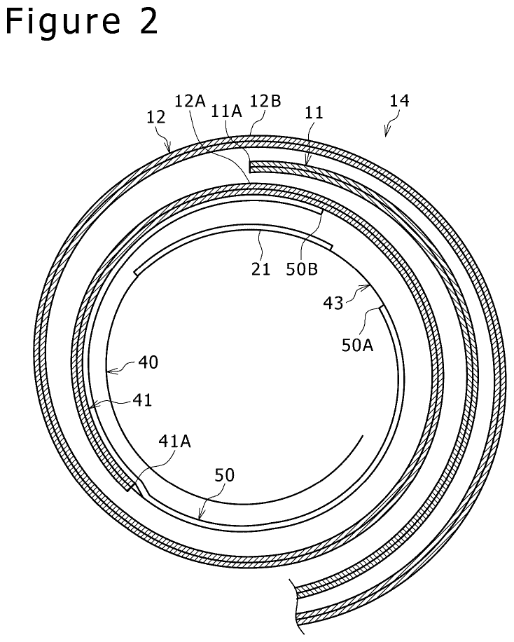

The electrode assembly 14 has a positive electrode lead 20 joined to the positive electrode 11, and a negative electrode lead 21 joined to the negative electrode 12. In the present embodiment, the positive electrode lead 20 is provided at a longitudinal center portion of the positive electrode 11 which is a position away from a winding start side end and a winding finish side end of the electrode assembly 14. On the other hand, the negative electrode lead 21 is provided at one end portion of the negative electrode 12 in the longitudinal direction that is located on a winding start side of the electrode assembly 14. The negative electrode 12 has a first core exposed portion 43 (see FIGS. 2 to 4) where the negative electrode mixture layer 41 is not present. The negative electrode lead 21 is joined to the core exposed portion 43.

The positive electrode 11 has a positive electrode core 30, and a positive electrode mixture layer 31 formed on at least one surface of the core. For the positive electrode core 30, a foil of a metal, such as aluminum or an aluminum alloy, which is stable within a potential range of the positive electrode 11, a film in which such a metal is disposed on a surface layer thereof, and the like may be used. The positive electrode mixture layer 31 includes a positive electrode active material, a conductive agent such as acetylene black, and a binder such as polyvinylidene fluoride (PVdF), and is preferably formed on each surface of the positive electrode core 30. A thickness of the positive electrode mixture layer 31 is, for example, greater than or equal to 40 μm and less than or equal to 100 μm. For the positive electrode active material, for example, a lithium-transition metal composite oxide containing Ni, Co, Mn, and Al is used. Note that the positive electrode lead 20 is preferably joined directly to the positive electrode core 30 by means of ultrasonic welding or the like.

The negative electrode 12 has a negative electrode core 40, and a negative electrode mixture layer 41 formed on at least one surface of the core. For the negative electrode core 40, a foil of a metal, such as copper or a copper alloy, which is stable within a potential range of the negative electrode 12, a film in which such a metal is disposed on a surface layer thereof, and the like may be used. The negative electrode mixture layer 41 includes a negative electrode active material, and a binder such as a styrene-butadiene rubber (SBR), and is preferably formed on each surface of the negative electrode core 40. A thickness of the negative electrode mixture layer 41 is, for example, greater than or equal to 40 μm and less than or equal to 100 μm. For the negative electrode active material, for example, graphite or an Si-containing material is used. The negative electrode lead 21 is preferably joined directly to the negative electrode core 40 by means of ultrasonic welding or the like.

The cylindrical battery 10 comprises an upper insulating plate 18 that is disposed between the sealing assembly 17 and an electrode group, and has an opening portion through which the positive electrode lead 20 passes. In the present specification, the electrode group means a portion of the electrode assembly 14 including the positive electrode 11, the negative electrode 12, and the separator 13, but not including the positive electrode lead 20 and the negative electrode lead 21. The cylindrical battery 10 comprises a lower insulating plate 19 that is disposed between a bottom portion of the exterior housing can 16 and the electrode group, and has an opening portion through which the negative electrode lead 21 passes.

In the example illustrated in FIG. 1, the positive electrode lead 20 passes through the opening portion in the upper insulating plate 18 and extends toward the sealing assembly 17 side, and the negative electrode lead 21 passes through the opening portion in the lower insulating plate 19 and extends toward the bottom portion side of the exterior housing can 16. The positive electrode lead 20 is connected to a lower surface of a bottom plate 23 of the sealing assembly 17 by means of welding or the like, and the sealing assembly 17 serves as a positive electrode terminal. The negative electrode lead 21 is connected to an inner surface of the bottom portion of the exterior housing can 16 by means of welding or the like, and the exterior housing can 16 serves as a negative electrode terminal.

On the outermost circumference surface of the electrode assembly 14, the negative electrode 12 is disposed, and a second core exposed portion 44 where a surface of the negative electrode core 40 is exposed is provided. Then, the core exposed portion 44 is in contact with an inner circumferential surface of the exterior housing can 16. When the core exposed portion 44 is in contact with the inner circumferential surface of the exterior housing can 16 serving as the negative electrode terminal, both end portions of the negative electrode 12 in the longitudinal direction are electrically connected to the exterior housing can 16, so that good current collecting performance can be ensured. Although the core exposed portion 44 may be provided in a part of the outermost circumferential surface of the electrode assembly 14, the core exposed portion is preferably provided in the entire area of the outermost circumferential surface. For example, a portion where the negative electrode mixture layer 41 is not present on each surface of the negative electrode core 40 is provided with a length of one lap or more of the electrode assembly 14 from the winding finish end of the negative electrode 12.

The exterior housing can 16 is a bottomed cylindrical metallic container. A gasket 28 is provided between the exterior housing can 16 and the sealing assembly 17, and the interior of the battery is sealed. The exterior housing can 16 has the grooved portion 22 which is formed by, for example, pressing a side surface portion from the outside. The grooved portion 22 is preferably formed in an annular shape along the circumferential direction of the exterior housing can 16, and supports the sealing assembly 17 on its upper surface. In addition, an upper end portion of the exterior housing can 16 is bent inward and is crimped on a peripheral edge portion of the sealing assembly 17.

The sealing assembly 17 has a stacked structure of the bottom plate 23, a lower vent member 24, an insulating member 25, an upper vent member 26, and a cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected to each other at respective center portions, and the insulating member 25 is interposed between the circumferential edge portions of the vent members 24 and 26. If the internal pressure of the battery increases, the lower vent member 24 is deformed to push up the upper vent member 26 toward the cap 27 side and ruptures, resulting in cutting off of a current pathway between the lower vent member 24 and the upper vent member 26. If the internal pressure further increases, the upper vent member 26 ruptures, and gas is discharged through an opening portion of the cap 27.

### [Tape]

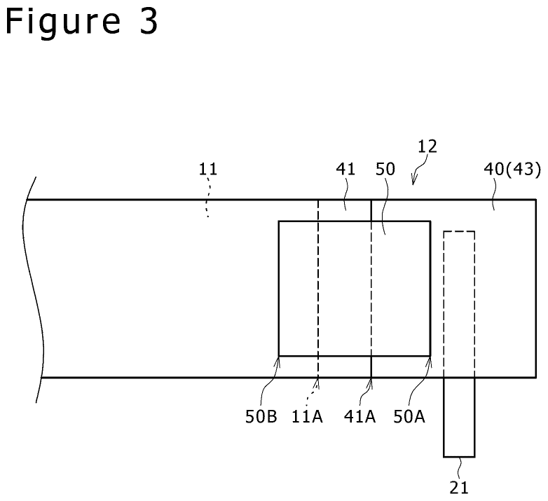

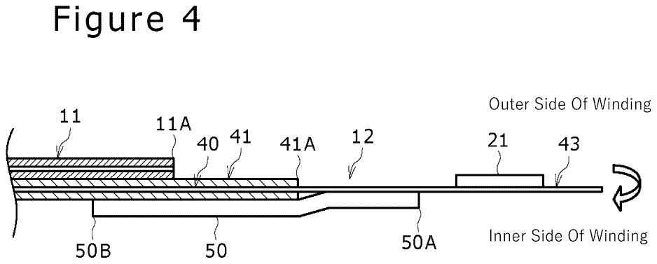

Referring to FIGS. 2 to 4, the tape 50 will be described. FIG. 2 is a sectional view (sectional view along a stacking direction of the electrode assembly 14) perpendicular to a winding axis direction on the winding start side of the electrode assembly 14. FIG. 3 is a schematic diagram illustrating, in a developed form, the winding start side of the electrode assembly 14. FIG. 4 is a schematic diagram illustrating a radial cross section of FIG. 3. In FIGS. 2 to 4, the separator 13 is not illustrated for the sake of clarity of illustration.

The tape 50 is stuck to the winding inner surface on the winding start side of the negative electrode 12. More specifically, the tape 50 is stuck to a portion of the winding inner surface of the negative electrode 12 so as to straddle a position facing the inner side of the winding of the winding start side end 11A of the positive electrode 11. That is, a winding start side end 50A of the tape 50 is located on the winding start side with respect to the first facing position 12A, and a winding finish side end 50B of the tape 50 is located on the winding finish side with respect to the first facing position 12A. Note that at the winding start side end 11A of the positive electrode 11, the positive electrode mixture layer 31 is formed on the positive electrode core 30 as described above.

Here, in the cylindrical battery 10, a step is formed in the winding start side end 11A of the positive electrode 11 along the winding direction, which may cause, when charge and discharge cycles are repeated, deformation of a portion of the negative electrode 12 facing the inner side of the winding of the winding start side end portion of the positive electrode. In a case where deformation of the portion of the negative electrode 12 occurs, a distance between the positive and negative electrodes varies, which may result in inhomogeneous charging and discharging reaction and degradation of cycle characteristics.

Using the tape 50 can suppress deformation of the portion of the negative electrode 12 facing the inner side of the winding of the winding start side end 11A of the positive electrode 11 where the above-described step is formed, by reinforcing the portion of the negative electrode 12. This makes it possible to suppress a variation in distance between the positive and negative electrodes, and suppress inhomogeneous charging and discharging reaction and degradation of cycle characteristics.

In addition, since the tape 50 is stuck to the winding inner surface of the negative electrode 12 on the winding start side of the negative electrode 12 which does not contribute to the electrolytic reaction, using the tape 50 can avoid a decrease in battery capacity of the cylindrical battery 10 without the tape 50 hindering the electrolytic reaction.

Here, the position of the winding finish side end 50B of the tape 50 will be described in detail. The winding finish side end 50B of the tape 50 is located at a distance of greater than or equal to 2 mm toward the winding finish side from the first facing position 12A. This makes it possible to reliably reinforce the portion of the negative electrode 12 facing the winding start side end 11A of the positive electrode 11 where the above-described step is formed.

The winding finish side end 50B of the tape 50 is located on the winding start side with respect to the second facing position 12B. That is, the tape 50 is stuck to a portion of the negative electrode 12 so as not to face the positive electrode 11 through the separator 13. This makes it possible to avoid a decrease in battery capacity of the cylindrical battery 10 without the tape 50 hindering the electrolytic reaction.

Next, the position of the winding start side end 50A of the tape 50 will be described in detail. The winding start side end 50A of the tape 50 is located on the winding start side with respect to the winding start side end 41A of the negative electrode mixture layer 41 of the winding inner surface of the negative electrode 12. More specifically, the winding start side end 50A is preferably located at a distance of greater than or equal to 2 mm toward the winding start side from the winding start side end 41A of the negative electrode mixture layer 41. This makes it possible to reliably reinforce the portion of the negative electrode 12 facing the winding start side end portion 11A of the positive electrode 11.

In addition, the winding start side end 50A of the tape 50 is preferably located on the winding finish side with respect to the negative electrode lead 21. In other words, the winding start side end 50A of the tape 50 does not preferably straddle the negative electrode lead 21. This makes it possible to avoid unnecessarily lengthening the tape 50.

Furthermore, the length (width) of the tape 50 in a winding axis direction will be described in detail. The length of the tape 50 in the winding axis direction is preferably greater than or equal to 60% of the length of the negative electrode 12 in the winding axis direction, more preferably greater than or equal to 80%. A center position of the tape 50 in the winding axis direction is preferably substantially in alignment with a center position of the negative electrode 12 in the winding axis direction. This makes it possible to more reliably reinforce the portion of the negative electrode 12 facing the winding start side end 11A of the positive electrode 11.

The tape 50 preferably has an insulation property. However, in a case where the tape 50 is stuck to a range of the negative electrode 12 which does not face the positive electrode 12 through the separator 13, the tape 50 does not particularly need to have an insulation property. The tape 50 includes, for example, a tape substrate, and an adhesive layer formed on one surface of the substrate, and is stuck to the winding inner surface of the negative electrode 12 through the adhesive layer.

Examples of resin forming the tape substrate include a polyester such as poly ethylene terephthalate (PET), a polypropylene (PP), a polyimide (PI), a poly phenylene sulfide (PPS), a poly ether imide (PEI), and a polyamide. The adhesive forming the adhesive layer is preferably an adhesive property at room temperature. Examples of the adhesive include an acrylic-based adhesive and a synthetic rubber-based adhesive. Note that the tape 50 may contain an insulating inorganic filler.

It should be noted that the present disclosure is not limited to the above-described embodiments and modifications thereof, and it goes without saying that various changes and improvements can be made within the scope of the matters described in the claims of the present application.

Although the present disclosure is described in further detail with reference to experimental examples below, the present disclosure is not limited by these experimental examples.

### Experimental Example 1

### [Production of Positive Electrode]

As the positive electrode active material, lithium nickel oxide (LiNi_{0.88}Co_{0.09}Al_{0.03}O₂) containing cobalt and aluminum was used. The positive electrode active material, acetylene black, and polyvinylidene fluoride were mixed in a solid mass ratio of 98:1:1, and N-methylpyrrolidone (NMP) was used as a dispersion medium to prepare a positive electrode mixture slurry. The slurry was applied to both surfaces of the positive electrode core formed of an elongated aluminum foil having a thickness of 15 μm, and the applied film was dried and compressed to obtain a positive electrode (58.0 mm in width, 850 mm in length, and 110 μm in thickness) in which the positive electrode mixture layer was formed on both surfaces of the positive electrode core. Note that a core exposed portion where the positive electrode mixture layer was not present at a longitudinal center portion of the positive electrode was provided, the positive electrode lead made of aluminum was joined to the exposed portion by means of ultrasound welding, and a PI tape was stuck to both surfaces to protect a current collector exposed portion.

### [Production of Negative Electrode]

As the negative electrode active material, graphite powder and an Si-containing material which were mixed in a mass ratio of 95:5 were used. The negative electrode active material, dispersion of styrene-butadiene rubber, and sodium carboxymethylcellulose were mixed in a solid mass ratio of 98:1:1, and water was used as a dispersion medium to prepare a negative electrode mixture slurry. The slurry was applied to both surfaces of the negative electrode core formed of an elongated copper foil having a thickness of 8 μm, and the applied film was dried and compressed to obtain a negative electrode (59.3 mm in width, 955 mm in length, and 114 μm in thickness) in which the negative electrode mixture layer was formed on both surfaces of the negative electrode core. Note that first and second core exposed portions where the negative electrode mixture layer was not present in predetermined length ranges from both ends of the negative electrode in the longitudinal direction were provided, and the negative electrode lead made of nickel was joined to the first core exposed portion by means of ultrasound welding.

### [Production of Electrode Assembly]

The above-described positive electrode, the above-described negative electrode, and a separator made of polyethylene were spirally wound using a cylindrical winding core member to obtain a wound electrode assembly. At this time, the negative electrode was disposed so that the first core exposed portion of the negative electrode to which the negative electrode lead was joined was located on the winding start side of the electrode assembly. That is, the second core exposed portion of the negative electrode was located on the winding finish side of the electrode assembly. After forming the wound structure of the electrode assembly, the winding core member was removed to obtain a wound electrode assembly in which a cavity was formed in the winding core portion.

In Experimental Example 1, the tape was stuck to the winding inner surface of the negative electrode so as to straddle the negative electrode mixture layer from the winding finish side of the negative electrode lead. At this time, the tape was disposed so that the winding finish side end of the tape was located on the winding start side with respect to the first facing position of the negative electrode which is a position facing the inner side of the winding of the winding start side end of the positive electrode (so as not to overlap with the first facing position). The tape made of polypropylene and having a thickness of 0.03 mm was used. The length of the tape in the winding axis direction was set to 50 mm.

### [Preparation of Non-Aqueous Electrolytic Solution]

5 parts by mass of vinylene carbonate (VC) was added to 100 parts by mass of a mixed solvent of ethylene carbonate (EC) and dimethyl carbonate (DMC) mixed in a volume ratio of 1:3 (25 °C), and 1.3 mol/liter LiPF₆ was dissolved to prepare a non-aqueous electrolytic solution.

### [Production of Cylindrical Battery]

After insulating plates were disposed on the upper and lower sides of the above-described electrode assembly, the negative electrode lead was welded to a bottom inner surface of the bottomed cylindrical exterior housing can, the positive electrode lead was welded to an internal terminal plate of the sealing assembly, and the electrode assembly was housed in the exterior housing can. Subsequently, the non-aqueous electrolytic solution was injected into the exterior housing can by the depressurizing method, and the opening portion of the exterior housing can was sealed with the sealing assembly through a gasket to obtain a cylindrical battery. Note that the second core exposed portion of the negative electrode forms the outermost circumferential surface of the electrode assembly and contacts the inner circumferential surface of the exterior housing can.

### Experimental Example 2

A cylindrical battery was produced in a similar manner to Example 1 except that the winding finish side end of the tape was disposed at a distance of 2 mm toward the winding finish side from the first facing position.

### Experimental Example 3

A cylindrical battery was produced in a similar manner to Experimental Example 2 except that the length of the tape in the winding axis direction was set to 30 mm.

### [Evaluation of Electrode Plate Deformation (Presence or Absence of Buckling)]

The battery of each experimental example was subjected to 200 times of charge and discharge cycles under the following conditions. Subsequently, cross sectional observation of the center portion of the battery was performed using an X-ray CT device to confirm the deformation of the negative electrode portion facing the inner side of the winding of the winding start side end portion of the positive electrode.
Charging: 3000 mA (1C)-4.20 V 100 mA cut pause for 30 minutes
Discharging: 15000 mA (5C)-2.50 V cut pause for 60 minutes

TABLE 1

| | | | Deformation |
|---|---|---|---|
| | Tape width | Positional | of negative |
| | (Ratio to | relationship | electrode portion |
| | negative | between first | facing winding start |
| | electrode | facing position | side end portion of |
| | width) | and tape | positive electrode |
| Experimental | 50 mm (80%) | No overlap | With deformation |
| example 1 | | | |
| Experimental | 50 mm (80%) | With overlap | No deformation |
| example 2 | | | |
| Experimental | 30 mm (50%) | With overlap | With deformation |
| example 3 | | | |

As shown in Table 1, in the batteries of Experimental Examples 1 and 3, buckling deformation was observed in which the negative electrode portion facing the inner side of the winding of the winding start side end portion of the positive electrode was buckled toward the inner side of the winding. In the battery of Experimental Example 2, no buckling deformation was observed in the negative electrode portion.

The present disclosure is further described by the following embodiments.

Configuration 1: A cylindrical battery comprising an electrode assembly in which a positive electrode, and a negative electrode including a core and a mixture layer are spirally wound with a separator interposed between the positive electrode and the negative electrode, wherein the negative electrode has a tape stuck to a winding inner surface so as to straddle, in a winding direction, a first facing position facing an inner side of winding of a winding start side end of the positive electrode.

Configuration 2: The cylindrical battery according to configuration 1, wherein a winding finish side end of the tape is located at a distance of greater than or equal to 2 mm toward a winding finish side from the first facing position.

Configuration 3: The cylindrical battery according to configuration 1 or 2, wherein a winding start side end of the tape is located on a winding start side with respect to a winding start side end portion of the mixture layer of a winding inner surface.

Configuration 4: The cylindrical battery according to any one of configurations 1 to 3, wherein a length of the tape in a winding axis direction is greater than or equal to 60% of a length of the negative electrode in the winding axis direction.

Configuration 5: The cylindrical battery according to any one of configurations 1 to 4, wherein a winding finish side end of the tape is located on a winding start side with respect to a second facing position of the negative electrode facing an outer side of winding of the winding start side end of the positive electrode.

### REFERENCE SIGNS LIST

10 Cylindrical battery, 11 Positive electrode, 11A Winding start side end (positive electrode), 12 Negative electrode, 12A First facing position, 12B Second facing position, 13 Separator, 14 Electrode assembly, 16 Exterior housing can, 17 Sealing assembly, 18 Upper insulating plate, 19 Lower insulating plate, 20 Positive electrode lead, 21 Negative electrode lead, 22 Grooved portion, 23 Bottom plate, 24 Lower vent member 25, Insulating member, 26 Upper vent member, 27 Cap, 28 Gasket, 30 Positive electrode core, 31 Positive electrode mixture layer, 40 Negative electrode core, 41 Negative electrode mixture layer, 41A Winding start side end (negative electrode mixture layer), 43 Core exposed portion (first), 44 Core exposed portion (second), 50 Tape, 50A Winding start side end (tape), 50B Winding finish side end portion (tape)

1. A cylindrical battery, comprising an electrode assembly in which a positive electrode, and a negative electrode including a core and a mixture layer are spirally wound with a separator interposed between the positive electrode and the negative electrode, wherein
the negative electrode has a tape stuck to a winding inner surface so as to straddle, in a winding direction, a first facing position facing an inner side of winding of a winding start side end of the positive electrode.

2. The cylindrical battery according to claim 1, wherein
a winding finish side end of the tape is located at a distance of greater than or equal to 2 mm toward a winding finish side from the first facing position.

3. The cylindrical battery according to claim 2, wherein
a winding start side end of the tape is located on a winding start side with respect to a winding start side end of the mixture layer of a winding inner surface.

4. The cylindrical battery according to claim 3, wherein
a length of the tape in a winding axis direction is greater than or equal to 60% of a length of the negative electrode in the winding axis direction.

5. The cylindrical battery according to claim 1, wherein
a winding finish side end of the tape is located on a winding start side with respect to a second facing position of the negative electrode facing an outer side of winding of the winding start side end of the positive electrode.
